(19) United States
(12) Patent Application Publication
(10) Pub. No.: US 2012/0328469 A1
(43) Pub. Date: Dec. 27, 2012

(54) NANOWIRE PREPARATION METHODS, COMPOSITIONS, AND ARTICLES

(75) Inventors: Junping Zhang, Saint Paul, MN (US); Doreen C. Lynch, Afton, MN (US)

(73) Assignee: Carestream Health, Inc.

(21) Appl. No.: 13/439,983

(22) Filed: Apr. 5, 2012

Related U.S. Application Data
(60) Provisional application No. 61/500,649, filed on Jun. 24, 2011.

(51) Int. Cl. C22C 5/06; B22F 9/18; B82Y 40/00; B82Y 30/00

(52) U.S. Cl. 420/501; 75/343; 977/762; 977/896

(57) ABSTRACT

Methods of preparing nanowires, compositions, and articles are disclosed. Such methods can provide thin nanowires with reduced nanoparticle contamination. Compositions and articles comprising such nanowires are useful in electronics applications.

### CROSS REFERENCE TO RELATED APPLICATIONS

This application claims the benefit of U.S. Provisional Application No. 61/500,649, filed Jun. 24, 2011, entitled NANOWIRE PREPARATION METHODS, COMPOSITIONS, AND ARTICLES, which is hereby incorporated by reference in its entirety.

### BACKGROUND

The general preparation of silver nanowires (10-200 aspect ratio) is known. See, for example, Angew. Chem. Int. Ed., 2009, 48, 60, Y. Xia, Y. Xiong, B. Lim, S. E. Skrabalak, which is hereby incorporated by reference in its entirety. Such preparations typically employ Fe²⁺ or Cu²⁺ ions to “catalyze” the wire formation over other morphologies. The controlled preparation of silver nanowires having desired lengths and widths, however, is not known. For example, the Fe²⁺ produces a wide variety of lengths or thicknesses and the Cu²⁺ produces wires that are too thick for many applications.

When iron or copper are used, they are typically provided as the metal halide salts FeCl₂ or CuCl₂. See, for example, B. Wiley et al., Nano Letters, 2004, 4, 1733-1739 and K. E. Korte et al., J. Mats. Chem., 2008, 18, 437. Other metal halide salts have been used in nanowire synthesis. See, for example, J. Jiu, K. Murai, D. Kim, K. Kim, K. Suganuma, Mat. Chem. & Phys., 2009, 114, 333, which refers to NaCl, CoCl₂, CuCl₂, NiCl₂ and ZnCl₂, and S. Nandikonda, “Microwave Assisted Synthesis of Silver Nanorods,” M. S. Thesis, Auburn University, Auburn, Ala., USA, Aug. 9, 2010, which refers to NaCl, KCl, MgCl₂, CaCl₂, MnCl₂, CuCl₂, and FeCl₃, and Japanese patent application publication 2009-155674, which discloses SnCl₄. Use of NaCl is disclosed in S. Murali et al., Langmuir, 2010, 26(13), 11176-83 and US Patent Application Publication No. 2010/0148132. Use of KBr has been disclosed in, for example, D. Chen et al., J. Mater. Sci.: Mater. Electron., 2011, 22(1), 6-13; L. Hu et al., ACS Nano, 2010, 4(5), 2955-2963; and C. Chen et al, Nanotechnology, 2006, 17, 3933. Use of NaBr has been disclosed in, for example, L. Zhou et al., Appl. Phys. Letters, 2009, 94, 153102. See also Z. C. Li et al., Micro & Nano Letters, 2011, 6(2), 90-93; and B. J. Wiley et al., Langmuir, 2005, 21, 8077. U.S. patent application publication 2011/0173190 discloses nanowire preparation in the presence of tetra-n-butylammonium chloride.

### SUMMARY

At least a first embodiment provides methods comprising providing at least one first composition comprising at least one first reducible metal ion, and reducing the at least one first reducible metal ion to at least one first metal nanowire in the presence of at least one bromide ion, at least one chloride ion, at least one first alkali metal ion, and at least one second alkali metal ion, where the at least one first alkali metal ion and the at least one second alkali metal ion have different atomic numbers.

In at least some embodiments, the at least one first alkali metal ion or the at least one second metal ion may comprise a sodium ion. Or, in some cases, the at least one first alkali metal ion or the at least one second metal ion may comprise a potassium ion.

In any such methods, the at least one first reducible metal ion may, for example, comprise at least one coinage metal ion, or at least one ion of an IUPAC Group 11 element. An exemplary first reducible metal ion is a silver ion, which may, for example, be provided by such compounds as silver nitrate.

Other embodiments provide products produced by any such methods, such as, for example, metal nanowires. An exemplary metal nanowire is a silver nanowire. Such metal nanowires may, for example, comprise a smallest dimension between about 10 nm and about 100 nm, or from about 15 nm and about 80 nm. Such metal nanowires may, in some cases, comprise an aspect ratio between about 50 and about 10,000.

Still other embodiments provide articles comprising such products. Non-limiting examples of such articles include electronic displays, touch screens, portable telephones, cellular telephones, computer displays, laptop computers, tablet computers, point-of-purchase kiosks, music players, televisions, electronic games, electronic book readers, transparent electrodes, solar cells, light emitting diodes, other electronic devices, medical imaging devices, medical imaging media, and the like.

At least a second embodiment provides methods comprising providing at least one first composition comprising at least one first reducible metal ion, and reducing the at least one first reducible metal ion to at least one first metal nanowire in the presence of at least one bromide ion and at least one chloride ion, where the at least one chloride ion is provided by at least one first compound represented by NHₙR₄₋ₙCl, where n is 0, 1, 2, 3, or 4, or the at least one bromide ion may be provided by at least one second compound represented by NHₘR₄₋ₘBr, where m is 0, 1, 2, 3, or 4.

In at least some embodiments, the at least one first compound comprises at least one of ammonium chloride or tetramethylammonium chloride. In at least some embodiments, the at least one second compound comprises at least one of ammonium bromide or tetramethylammonium bromide. The reduction may, in some cases, occur in the presence of at least one alkali metal ion.

In any such methods, the at least one first reducible metal ion may, for example, comprise at least one coinage metal ion, or at least one ion of an IUPAC Group 11 element. An exemplary first reducible metal ion is a silver ion, which may, for example, be provided by such compounds as silver nitrate.

Other embodiments provide products produced by any such methods, such as, for example, metal nanowires. An exemplary metal nanowire is a silver nanowire. Such metal nanowires may, for example, comprise a smallest dimension between about 10 nm and about 100 nm, or from about 15 nm and about 80 nm. Such metal nanowires may, in some cases, comprise an aspect ratio between about 50 and about 10,000.

Still other embodiments provide articles comprising such products. Non-limiting examples of such articles include electronic displays, touch screens, portable telephones, cellular telephones, computer displays, laptop computers, tablet computers, point-of-purchase kiosks, music players, televisions, electronic games, electronic book readers, transparent electrodes, solar cells, light emitting diodes, other electronic devices, medical imaging devices, medical imaging media, and the like.

These embodiments and other variations and modifications may be better understood from the brief description of the drawings, description, exemplary embodiments, examples, drawings, and claims that follow. Any embodiments provided are given only by way of illustrative example. Other desirable objectives and advantages inherently achieved may occur or become apparent to those skilled in the art.

### BRIEF DESCRIPTION OF THE DRAWINGS

FIG. 1 shows an optical micrograph of the unpurified product of Example 1.

FIG. 2 shows a scanning electron micrograph of the purified product of Example 3.

FIG. 3 shows a scanning electron micrograph of the purified product of Example 3.

FIG. 4 shows a scanning electron micrograph of the purified product of Example 4.

FIG. 5 shows a scanning electron micrograph of the purified product of Example 5.

FIG. 6 shows a scanning electron micrograph of the purified product of Example 6.

FIG. 7 shows a scanning electron micrograph of the purified product of Example 6.

FIG. 8 shows a scanning electron micrograph of the purified product of Example 10.

FIG. 9 shows a scanning electron micrograph of the purified product of Example 10.

FIG. 10 shows an optical micrograph of the unpurified product of Example 12.

FIG. 11 shows a scanning electron micrograph of the purified product of Example 12.

FIG. 12 shows a scanning electron micrograph of the purified product of Example 12.

FIG. 13 shows an optical micrograph of the unpurified product of Example 13.

FIG. 14 shows a scanning electron micrograph of the purified product of Example 13.

FIG. 15 shows a scanning electron micrograph of the purified product of Example 13.

FIG. 16 shows a scanning electron micrograph of the purified product of Example 15.

FIG. 17 shows a scanning electron micrograph of the purified product of Example 15.

### DESCRIPTION

All publications, patents, and patent documents referred to in this document are incorporated by reference herein in their entirety, as though individually incorporated by reference.

U.S. Provisional Application No. 61/500,649, filed Jun. 24, 2011, entitled NANOWIRE PREPARATION METHODS, COMPOSITIONS, AND ARTICLES, is hereby incorporated by reference in its entirety.

The Applicant has discovered methods and compositions that are useful in preparing, for example, such products as ultra-thin nanowires with very little nanoparticle contamination. These and other embodiments are described in more detail in this disclosure.

### Reducible Metal Ions and Metal Products

Some embodiments provide methods comprising reducing at least one reducible metal ion to at least one metal. A reducible metal ion is a cation that is capable of being reduced to a metal under some set of reaction conditions. In such methods, the at least one first reducible metal ion may, for example, comprise at least one coinage metal ion. A coinage metal ion is an ion of one of the coinage metals, which include copper, silver, and gold. Or such a reducible metal ion may, for example, comprise at least one ion of an IUPAC Group 11 element. An exemplary reducible metal ion is a silver cation. Such reducible metal ions may, in some cases, be provided as salts. For example, silver cations might, for example, be provided as silver nitrate.

In such embodiments, the at least one metal is that metal to which the at least one reducible metal ion is capable of being reduced. For example, silver would be the metal to which a silver cation would be capable of being reduced.

### Nanostructures, Nanostructures, and Nanowires

In some embodiments, the metal product formed by such methods is a nanostructure, such as, for example, a one-dimensional nanostructure. Nanostructures are structures having at least one “nanoscale” dimension less than 300 nm, and at least one other dimension being much larger than the nanoscale dimension, such as, for example, at least about 10 or at least about 100 or at least about 200 or at least about 1000 times larger. Examples of such nanostructures are nanorods, nanowires, nanotubes, nanopyramids, nanoprisms, nanoplates, and the like. “One-dimensional” nanostructures have one dimension that is much larger than the other two dimensions, such as, for example, at least about 10 or at least about 100 or at least about 200 or at least about 1000 times larger.

Such one-dimensional nanostructures may, in some cases, comprise nanowires. Nanowires are one-dimensional nanostructures in which the two short dimensions (the thickness dimensions) are less than 300 nm, preferably less than 100 nm, while the third dimension (the length dimension) is greater than 1 micron, preferably greater than 10 microns, and the aspect ratio (ratio of the length dimension to the larger of the two thickness dimensions) is greater than five. Nanowires are being employed as conductors in electronic devices or as elements in optical devices, among other possible uses. Silver nanowires are preferred in some such applications.

Such methods may be used to prepare nanostructures other than nanowires, such as, for example, nanocubes, nanorods, nanopyramids, nanotubes, and the like. Nanowires and other nanostructure products may be incorporated into articles, such as, for example, electronic displays, touch screens, portable telephones, cellular telephones, computer displays, laptop computers, tablet computers, point-of-purchase kiosks, music players, televisions, electronic games, electronic book readers, transparent electrodes, solar cells, light emitting diodes, other electronic devices, medical imaging devices, medical imaging media, and the like.

### Preparation Methods

A common method of preparing nanostructures, such as, for example, nanowires, is the “polyol” process. Such a process is described in, for example, Angew. Chem. Int. Ed. 2009, 48, 60, Y. Xia, Y. Xiong, B. Lim, S. E. Skrabalak, which is hereby incorporated by reference in its entirety. Such processes typically reduce a metal cation, such as, for example, a silver cation, to the desired metal nanostructure product, such as, for example, a silver nanowire. Such a reduction may be carried out in a reaction mixture that may, for example, comprise one or more polyols, such as, for example, ethylene glycol (EG), propylene glycol, butanediol, glycerol, sugars, carbohydrates, and the like; one or more protecting agents, such as, for example, polyvinylpyrrolidinone (also known as polyvinylpyrrolidone or PVP), other polar polymers or copolymers, surfactants, acids, and the like; and one or more metal ions. These and other components may be used in such reaction mixtures, as is known in the art. The reduction may, for example, be carried out at one or more temperatures from about 90° C. to about 190° C.

### Chloride Ions and Bromide Ions

In at least a first embodiment, the reduction of the reducible metal ion occurs in the presence of at least one chloride ion, at least one bromide ion, at least one first alkali metal ion, and at least a second alkali metal ion, where the at least one first alkali metal ion and the at least one second alkali metal ion have different atomic numbers.

In at least some embodiments, the at least one first alkali metal ion or the at least one second metal ion may comprise a sodium ion. Or, in some cases, the at least one first alkali metal ion or the at least one second metal ion may comprise a potassium ion.

In some cases, such alkali metal ions may be provided by metal salts, such as, for example, potassium bromide, sodium chloride, and the like.

In at least a second embodiment, the reduction of at least one first reducible metal ion occurs in the presence of at least one bromide ion and at least one chloride ion, where the at least one chloride ion is provided by at least one first compound represented by NHₙR₄₋ₙCl, where n is 0, 1, 2, 3, or 4. Here, R represents alkyl or substituted alkyl groups, each of which may be independently selected from the others. For example, in at least some embodiments, the at least one first compound comprises at least one of ammonium chloride or tetramethylammonium chloride.

Such a reduction may, in some cases, occur in the presence of at least one alkali metal ion. Or, in some cases, the at least one bromide ion may be provided by at least one second compound represented by NHₘR₄₋ₘBr, where m is 0, 1, 2, 3, or 4. Here, R represents alkyl or substituted alkyl groups, each of which may be independently selected from the others. For example, in at least some embodiments, the at least one second compound comprises at least one of ammonium bromide or tetramethylammonium bromide.

In at least a third embodiment the reduction of at least one first reducible metal ion occurs in the presence of at least one bromide ion and at least one chloride ion, where the at least one bromide ion is provided by at least one first compound represented by NHₘR₄₋ₘBr, where m is 0, 1, 2, 3, or 4. Here, R represents alkyl or substituted alkyl groups, each of which may be independently selected from the others. For example, in at least some embodiments, the at least one first compound comprises at least one of ammonium bromide or tetramethylammonium bromide.

Such a reduction may, in some cases, occur in the presence of at least one alkali metal ion. Or, in some cases, the at least one chloride ion may be provided by at least one second compound represented by NHₙR₄₋ₙCl, where n is 0, 1, 2, 3, or 4. Here, R represents alkyl or substituted alkyl groups, each of which may be independently selected from the others. For example in at least some embodiments, the at least one second compound comprises at least of ammonium chloride or tetramethylammonium chloride.

At least a fourth embodiment provides methods comprising providing at least one first composition comprising at least one first reducible metal ion, and reducing the at least one first reducible metal ion to at least one first metal nanowire in the presence of at least one bromide ion and at least one chloride ion, where the at least one chloride ion is provided by at least one first compound represented by NHₙR₄₋ₙCl, where n is 0, 1, 2, 3, or 4, or the at least one bromide ion may be provided by at least one second compound represented by NHₘR₄₋ₘBr, where m is 0, 1, 2, 3, or 4.

In at least some embodiments, the at least one first compound comprises at least one of ammonium chloride or tetramethylammonium chloride. In at least some embodiments, the at least one second compound comprises at least one of ammonium bromide or tetramethylammonium bromide. The reduction may, in some cases, occur in the presence of at least one alkali metal ion.

By reducing the reducible metal ion using such methods, products such as ultra-thin nanowires may be produced. Such methods may, for example, be used to produce silver nanowires having a smallest dimension between about 10 nm and about 100 nm, or between about 15 nm and about 80 nm. Such nanowires may have lengths of, for example, 30 microns or longer.

### Exemplary Embodiments

U.S. Provisional Application No. 61/500,649, filed Jun. 24, 2011, entitled NANOWIRE PREPARATION METHODS, COMPOSITIONS, AND ARTICLES, which is hereby incorporated by reference in its entirety, disclosed the following 25 non-limiting exemplary embodiments:
A. A method comprising:

providing at least one first composition comprising at least one first reducible metal ion; and

reducing the at least one first reducible metal ion to at least one first metal in the presence of at least one bromide ion, at least one chloride ion, at least one first alkali metal ion, and at least one second alkali metal ion,

wherein the at least one first alkali metal ion and the at least one second alkali metal ion have different atomic numbers.
B. The method according to embodiment A, wherein the at least one first alkali metal ion or the at least one second alkali metal ion comprise a sodium ion.
C. The method according to embodiment A, wherein the at least one first alkali metal ion or the at least one second alkali metal ion comprise a potassium ion.
D. A method comprising:

providing at least one first composition comprising at least one first reducible metal ion, and

reducing the at least one first reducible metal ion to at least one first metal in the presence of at least one bromide ion and at least one chloride ion,

wherein the at least one chloride ion is provided by at least one first compound represented by NHₙR₄₋ₙCl, where n is 0, 1, 2, 3, or 4.
E. The method according to embodiment D, wherein the at least one first compound comprises at least one of ammonium chloride or tetramethylammonium chloride.
F. The method according to embodiment D, wherein the reduction occurs in the presence of at least one alkali metal ion.
G. The method according to embodiment D, wherein the at least one bromide ion is provided by at least one second compound represented by NHₙR₄₋ₙBr, where n is 0, 1, 2, 3, or 4.
H. A method comprising:

providing at least one first composition comprising at least one first reducible metal ion, and

reducing the at least one first reducible metal ion to at least one first metal in the presence of at least one bromide ion and at least one chloride ion,

wherein the at least one bromide ion is provided by at least one first compound represented by NHₙR₄₋ₙBr, where n is 0, 1, 2, 3, or 4.
J. The method according to embodiment H, wherein the at least one first compound comprises at least one of ammonium bromide or tetramethylammonium bromide.
K. The method according to embodiment H, wherein the reduction occurs in the presence of at least one alkali metal ion.
L. The method according to embodiment H, wherein at least one chloride ion is provided by at least one second compound represented by NHₙR₄₋ₙCl, where n is 0, 1, 2, 3, or 4.
M. The method according to embodiments A, D, or H, wherein the at least one first reducible metal ion comprises at least one coinage metal ion.
N. The method according to embodiments A, D, or H, wherein the at least one first reducible metal ion comprises at least one ion of an IUPAC Group 11 element.
P. The method according to embodiments A, D, or H, wherein the at least one first reducible metal ion comprises at least one silver ion.
Q. The method according to embodiments A, D, or H, wherein the at least one composition comprises silver nitrate.
R. The method according to embodiments A, D, or H, wherein the reduction occurs in the presence of at least one protecting agent.
S. The method according to embodiment A, D, or H, wherein the reduction occurs in the presence of at least one polyol.
T. A product comprising the at least one first metal produced by the method according to embodiments A, D, or H.
U. The product according to embodiment T comprising at least one metal nanowire.
V. The product according to embodiment T, wherein the at least one metal nanowire comprises at least one silver nanowire.
W. The product according to embodiment T, wherein the at least one metal nanowire comprises a smallest dimension between about 10 nm and about 100 nm.
X. The product according to embodiment T, wherein the at least one metal nanowire comprises a smallest dimension between about 15 nm and about 80 nm.
Y. The product according to embodiment T, wherein the at least one metal nanowire comprises an aspect ratio between about 50 and about 10,000.
Z. An article comprising at least one product according to embodiment T.
AA. The article according to embodiment Z comprising at least one of an electronic display, a touch screen, a portable telephone, a cellular telephone, a computer display, a laptop computer, a tablet computer, a point-of-purchase kiosk, a music player, a television, an electronic game, an electronic book reader, a transparent electrode, a solar cell, a light emitting diode, an electronic device, a medical imaging device, or a medical imaging medium.

### EXAMPLES

### Example 1

A 500 mL reaction flask containing 300 mL ethylene glycol (EG), 10.0 g polyvinylpyrrolidinone (PVP, 55,000 weight-average molecular weight), 106.2 mg sodium chloride, and 62.5 mg potassium bromide was heated to 170° C. while bubbling nitrogen through its contents using a TEFLON® fluoropolymer tube. After the flask's contents reached 170° C., bubbling was discontinued and the reaction flask headspace was instead blanketed with nitrogen. 55 mL of 0.324 M AgNO₃ in EG, which had been degassed by bubbling nitrogen through it, was then added to the reaction flask at a constant rate of 2.4 mL/min using a syringe pump. After addition of the AgNO₃ solution, the flask was held at temperature for 60 min, after which the reaction was quenched by immersing the flask in ice.

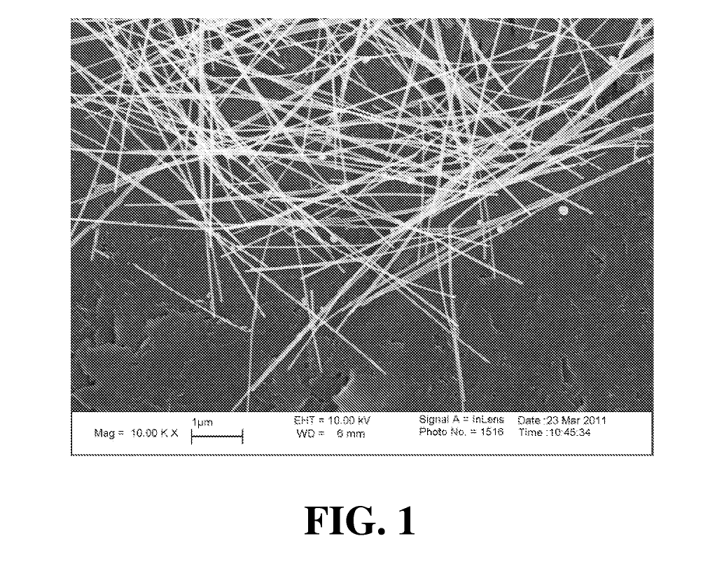

The reaction product was then washed with acetone and isopropanol, then centrifuged to obtain the purified product silver nanowires. The average nanowire diameter was determined by scanning electron microscopy to be 41±9 nm. FIG. 1 shows a scanning electron micrograph of the purified product.

### Example 2

### Comparative

A 500 mL reaction flask containing 300 mL EG, 10.0 g PVP, and 61.0 mg potassium bromide was heated to 170° C. while bubbling nitrogen through its contents using a TEFLON® fluoropolymer tube. After the flask's contents reached 170° C., bubbling was discontinued and the reaction flask headspace was instead blanketed with nitrogen. 60 mL of 0.324 M AgNO₃ in EG, which had been degassed by bubbling nitrogen through it, was then added to the reaction flask at a constant rate of 2.4 mL/min using a syringe pump. After addition of the AgNO₃ solution, the flask was held at temperature for 140 min, after which the reaction was quenched by immersing the flask in ice.

The reaction product was then washed with acetone and isopropanol, then centrifuged. The recovered product consisted primarily of nanoparticles, accompanied by short wires.

### Example 3

### Comparative

A 500 mL reaction flask containing 470 mL EG, 5.0 g PVP, and 21.0 mg sodium chloride was heated to 170° C. while bubbling nitrogen through its contents using a TEFLON® fluoropolymer tube. After the flask's contents reached 170° C., bubbling was discontinued and the reaction flask headspace was instead blanketed with nitrogen. 30 mL of 0.324 M AgNO₃ in EG, which had been degassed by bubbling nitrogen through it, was then added to the reaction flask at a constant rate of 1.2 mL/min using a syringe pump. After addition of the AgNO₃ solution, the flask was held at temperature for 45 min, after which the reaction was quenched by immersing the flask in ice.

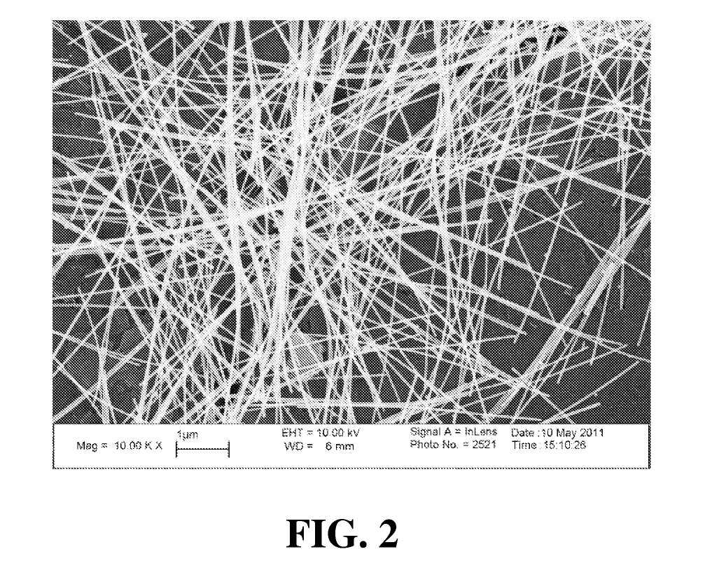

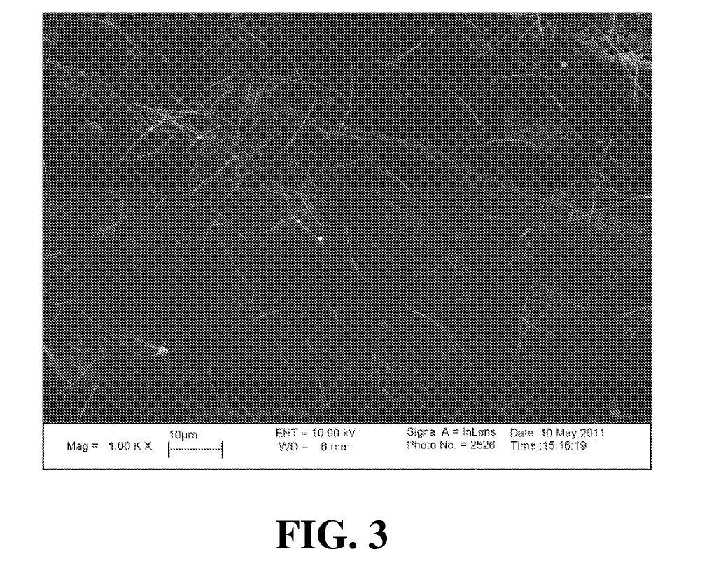

The reaction product was then washed with acetone and isopropanol, then centrifuged. The average nanowire diameter was determined by scanning electron microscopy to be 46±9 nm, but the average nanowire length was only 7±3 μm. FIGS. 2 and 3 show scanning electron micrographs of the silver nanowire product.

### Example 4

### Comparative

A 500 mL reaction flask containing 470 mL EG, 5.0 g PVP 21.1 mg sodium chloride, and 17.1 mg potassium nitrate was heated to 170° C. while bubbling nitrogen through its contents using a TEFLON® fluoropolymer tube. After the flask's contents reached 170° C., bubbling was discontinued and the reaction flask headspace was instead blanketed with nitrogen. 30 mL of 0.324 M AgNO₃ in EG, which had been degassed by bubbling nitrogen through it, was then added to the reaction flask at a constant rate of 1.2 mL/min using a syringe pump. After addition of the AgNO₃ solution, the flask was held at temperature for 45 min, after which the reaction was quenched by immersing the flask in ice.

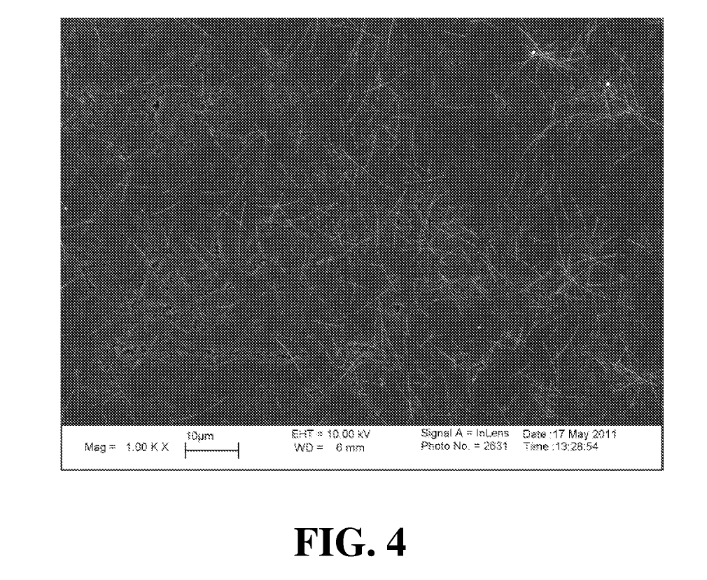

The reaction product was then washed with acetone and isopropanol, then centrifuged. The average nanowire diameter was determined by scanning electron microscopy to be 43±9 nm, but the average nanowire length was only 5±3 μm. FIG. 4 shows a scanning electron micrograph of the silver nanowire product.

### Example 5

A 500 mL reaction flask containing 300 mL EG, 10.0 g PVP, 12.3 mg sodium chloride, and 62.8 mg potassium bromide was heated to 170° C. while bubbling nitrogen through its contents using a TEFLON® fluoropolymer tube. After the flask's contents reached 170° C., bubbling was discontinued and the reaction flask headspace was instead blanketed with nitrogen. 55 mL of 0.324 M AgNO₃ in EG, which had been degassed by bubbling nitrogen through it, was then added to the reaction flask at a constant rate of 2.4 mL/min using a syringe pump. After addition of the AgNO₃ solution, the flask was held at temperature for 10 min, after which the reaction was quenched by immersing the flask in ice.

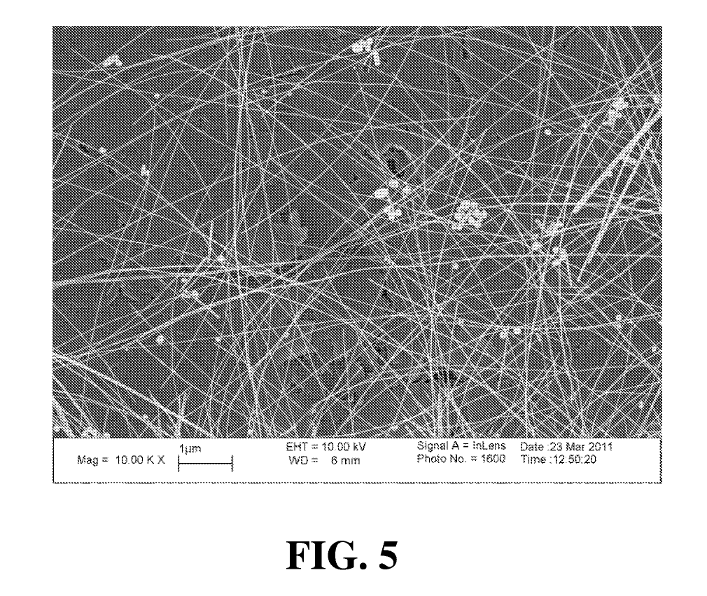

The reaction product was then washed with acetone and isopropanol, then centrifuged. The average nanowire diameter was determined by scanning electron microscopy to be 23±6 nm. FIG. 5 shows a scanning electron micrograph of the silver nanowire product.

### Example 6

A 500 mL reaction flask containing 300 mL EG, 6.67 g PVP, 20.7 mg sodium chloride, and 14.6 mg potassium bromide was heated to 170° C. while bubbling nitrogen through its contents using a TEFLON® fluoropolymer tube. After the flask's contents reached 170° C., bubbling was discontinued and the reaction flask headspace was instead blanketed with nitrogen. 30 mL of 0.324 M AgNO₃ in EG, which had been degassed by bubbling nitrogen through it, was then added to the reaction flask at a constant rate of 1.2 mL/min using a syringe pump. After addition of the AgNO₃ solution, the flask was held at temperature for 45 min, after which the reaction was quenched by immersing the flask in ice.

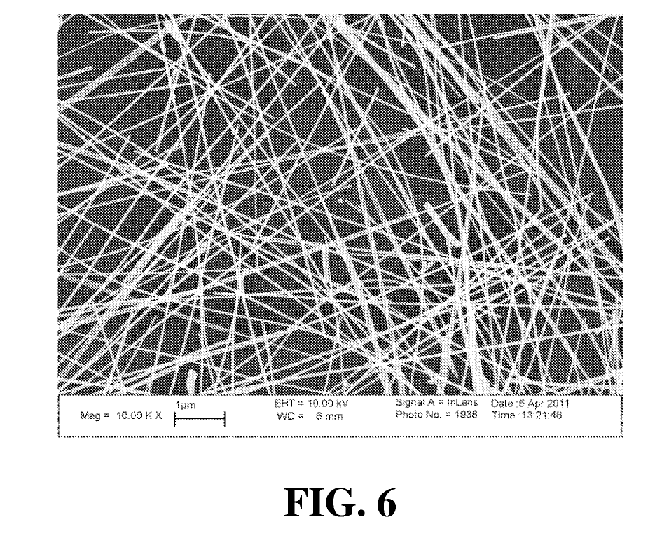

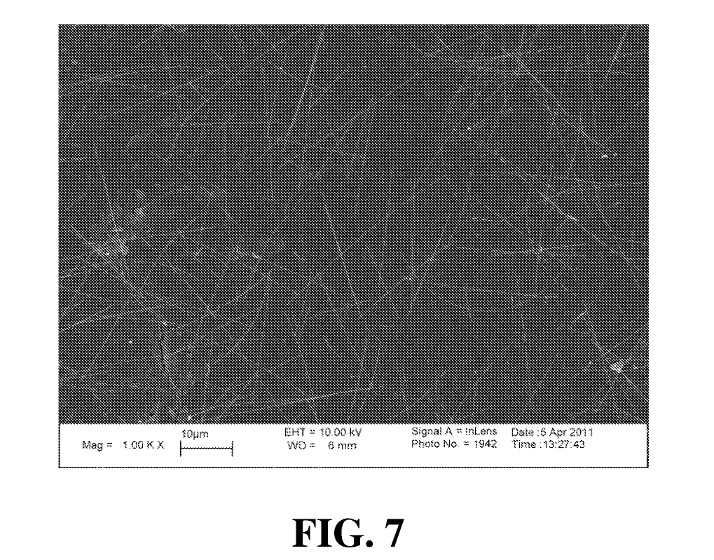

The reaction product was then washed with acetone and isopropanol, then centrifuged. The average nanowire diameter was determined by scanning electron microscopy to be 50±9 nm and the average nanowire length was 15.7±9.6 μm. FIGS. 6 and 7 show scanning electron micrograph of the silver nanowire product.

### Example 7

The procedure according to Example 6 was repeated, using 470 mL EG, 6.67 g PVP, 27.4 mg potassium chloride in place of the sodium chloride, and 15.0 mg potassium bromide. The silver nitrate solution was added over 25 min, after which the reaction flask was held at temperature for 60 min. The resulting silver nanowires had an average diameter of 44.4±5.6 nm and an average length of 9±3 μm.

### Example 8

The procedure according to Example 6 was repeated, using 470 mL EG, 5.0 g PVP, 14.1 mg sodium chloride, and 13.3 mg potassium bromide. The silver nitrate solution was added over 29 min, after which the reaction flask was held at temperature for 39 min. The resulting silver nanowires had an average diameter of 38.7±6.5 nm and an average length of 12±8.9 μm.

### Example 9

The procedure according to Example 8 was repeated. The resulting silver nanowires had an average diameter of 44.1±8.2 nm and an average length of 10.6±6 μm.

### Example 10

A 500 mL reaction flask containing 470 mL EG, 5.0 g PVP, 20.8 mg sodium chloride, and 20 mg potassium bromide was heated to 170° C. while bubbling nitrogen through its contents using a TEFLON® fluoropolymer tube. After the flask's contents reached 170° C., bubbling was discontinued and the reaction flask headspace was instead blanketed with nitrogen. 30 mL of 0.324 M AgNO₃ in EG, which had been degassed by bubbling nitrogen through it, was then added to the reaction flask at a constant rate of 1.2 mL/min using a syringe pump. After addition of the AgNO₃ solution, the flask was held at temperature for 45 min, after which the reaction was quenched by immersing the flask in ice.

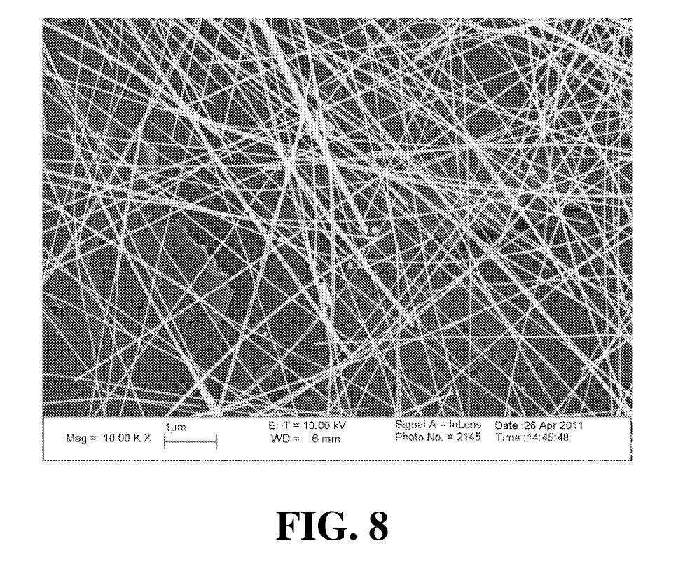

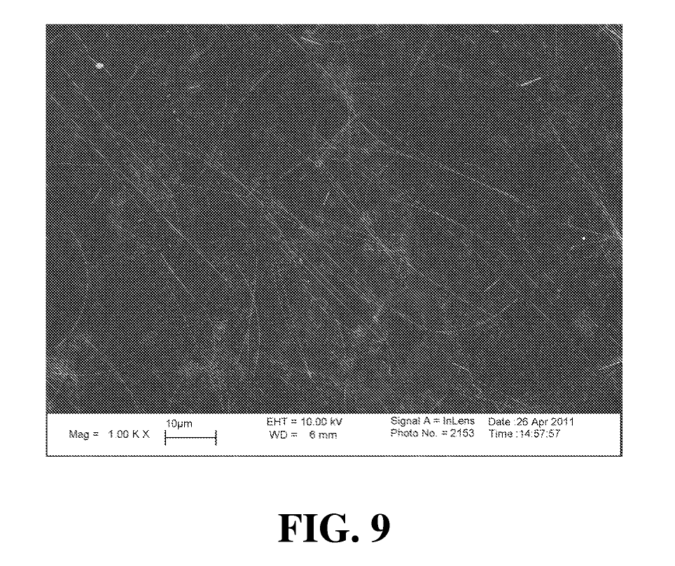

The reaction product was then washed with acetone and isopropanol, then centrifuged. The average nanowire diameter and length were determined by scanning electron microscopy to be 40±10 nm and 11.7±9.2 μm, respectively. FIGS. 8 and 9 show scanning electron micrographs of the silver nanowire product.

### Example 11

The procedure according to Example 10 was repeated. The resulting silver nanowires had an average diameter and length of 38.4±13.1 nm and 11.5±7.4 μm, respectively.

### Example 12

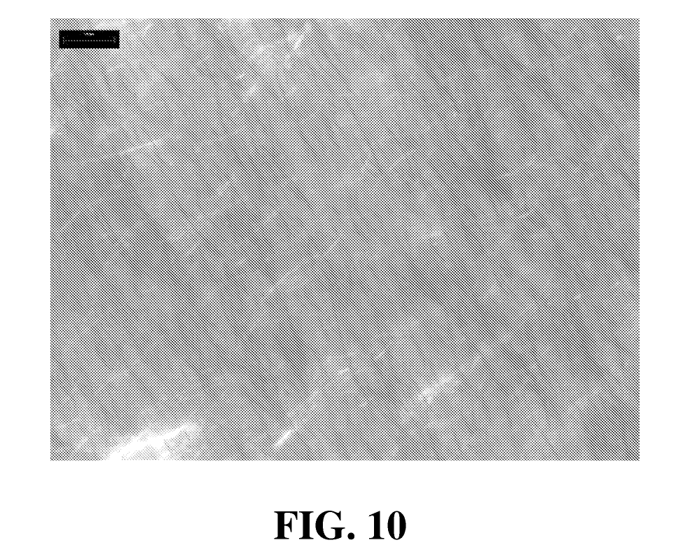

A 500 mL reaction flask containing 470 mL EG, 5.0 g PVP, 20.9 mg sodium chloride, and 26.3 mg tetramethylammonium bromide was heated to 170° C. while bubbling nitrogen through its contents using a TEFLON® fluoropolymer tube. After the flask's contents reached 170° C., bubbling was discontinued and the reaction flask headspace was instead blanketed with nitrogen. 30 mL of 0.324 M AgNO₃ in EG, which had been degassed by bubbling nitrogen through it, was then added to the reaction flask at a constant rate of 1.2 mL/min using a syringe pump. After addition of the AgNO₃ solution, the flask was held at temperature for 45 min, after which the reaction was quenched by immersing the flask in ice. FIG. 10 shows an optical micrograph of the unpurified silver nanowire product, with many wires longer than 20 μm.

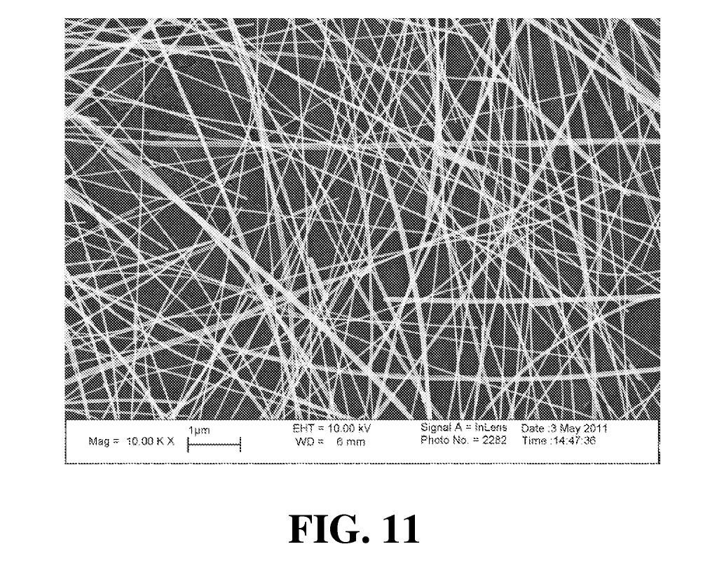

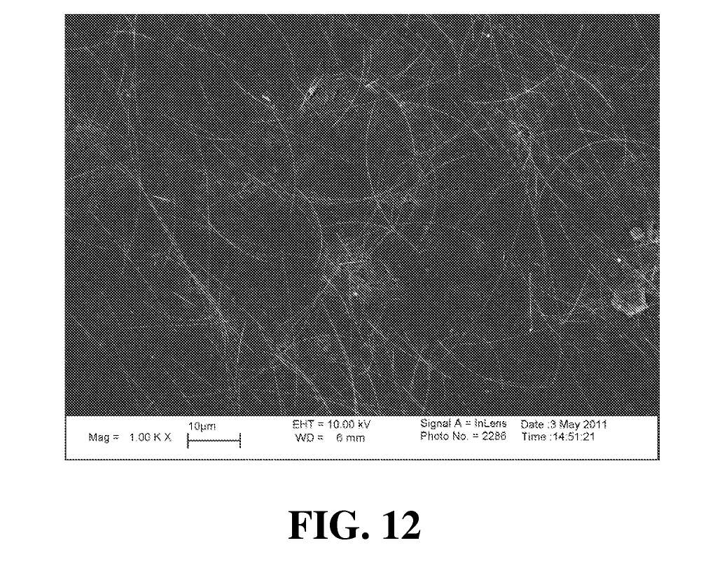

The reaction product was then washed with acetone and isopropanol, then centrifuged. The average nanowire diameter was determined by scanning electron microscopy to be 41±15 nm and the average nanowire length was 16±12 μm. FIGS. 11 and 12 show scanning electron micrograph of the purified silver nanowire product.

### Example 13

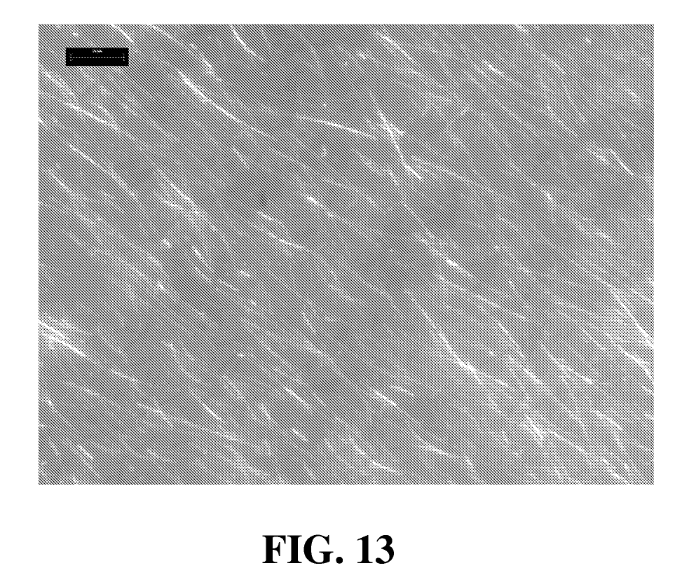

A 500 mL reaction flask containing 470 mL EG, 5.0 g PVP, 19.5 mg ammonium chloride, and 26 mg tetramethylammonium bromide was heated to 170° C. while bubbling nitrogen through its contents using a TEFLON® fluoropolymer tube. After the flask's contents reached 170° C., bubbling was discontinued and the reaction flask headspace was instead blanketed with nitrogen. 30 mL of 0.324 M AgNO₃ in EG, which had been degassed by bubbling nitrogen through it, was then added to the reaction flask at a constant rate of 1.2 mL/min using a syringe pump. After addition of the AgNO₃ solution, the flask was held at temperature for 25 min, after which the reaction was quenched by immersing the flask in ice. FIG. 13 shows an optical micrograph of the unpurified silver nanowire product, with many wires longer than 30 μm.

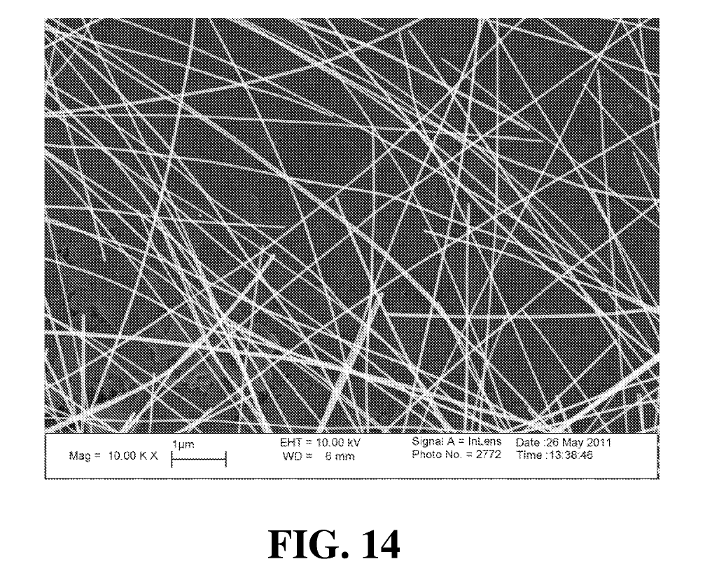

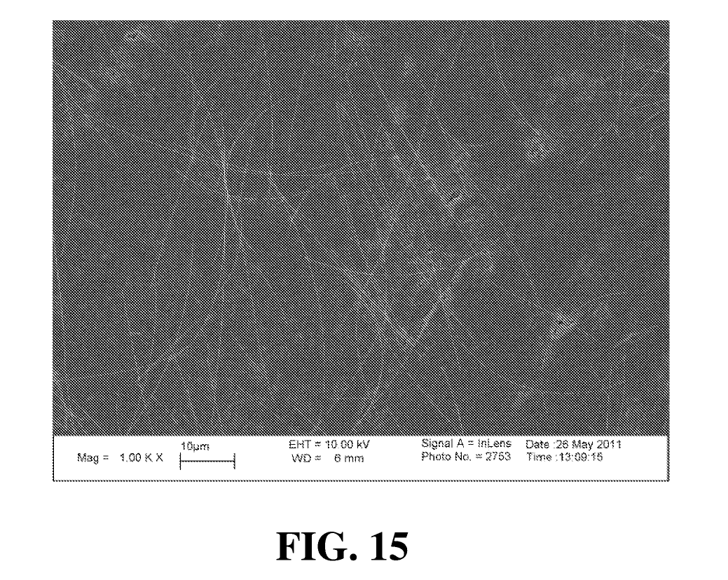

The reaction product was then washed with acetone and isopropanol, then centrifuged. The average nanowire diameter was determined by scanning electron microscopy to be 48±15 nm and the average nanowire length was 16±12 μm. FIGS. 14 and 15 show scanning electron micrographs of the purified silver nanowire product.

### Example 14

A 500 mL reaction flask containing 470 mL EG, 5.0 g PVP, 19.2 mg ammonium chloride, and 25.7 mg tetramethylammonium bromide was heated to 170° C. while bubbling nitrogen through its contents using a TEFLON® fluoropolymer tube. After the flask's contents reached 170° C., bubbling was discontinued and the reaction flask headspace was instead blanketed with nitrogen. 30 mL of 0.324 M AgNO₃ in EG, which had been degassed by bubbling nitrogen through it, was then added to the reaction flask at a constant rate of 1.2 mL/min using a syringe pump. After addition of the AgNO₃ solution, the flask was held at temperature for 35 min, after which the reaction was quenched by immersing the flask in ice.

The reaction product was then washed with acetone and isopropanol, then centrifuged. The average nanowire diameter was determined by scanning electron microscopy to be 46±12 nm.

### Example 15

A 500 mL reaction flask containing 470 mL EG, 5.0 g PVP, 19.1 mg ammonium chloride, and 16.1 mg ammonium bromide was heated to 170° C. while bubbling nitrogen through its contents using a TEFLON® fluoropolymer tube. After the flask's contents reached 170° C., bubbling was discontinued and the reaction flask headspace was instead blanketed with nitrogen. 30 mL of 0.324 M AgNO₃ in EG, which had been degassed by bubbling nitrogen through it, was then added to the reaction flask at a constant rate of 1.2 mL/min using a syringe pump. After addition of the AgNO₃ solution, the flask was held at temperature for 25 min, after which the reaction was quenched by immersing the flask in ice.

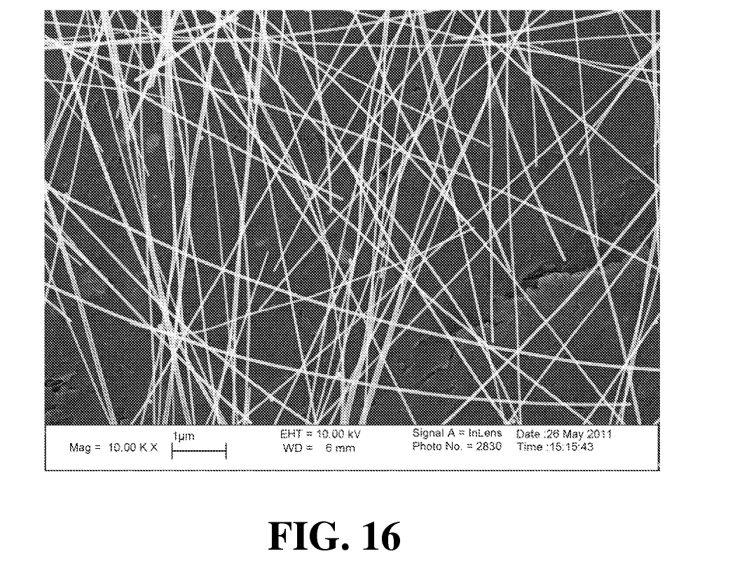

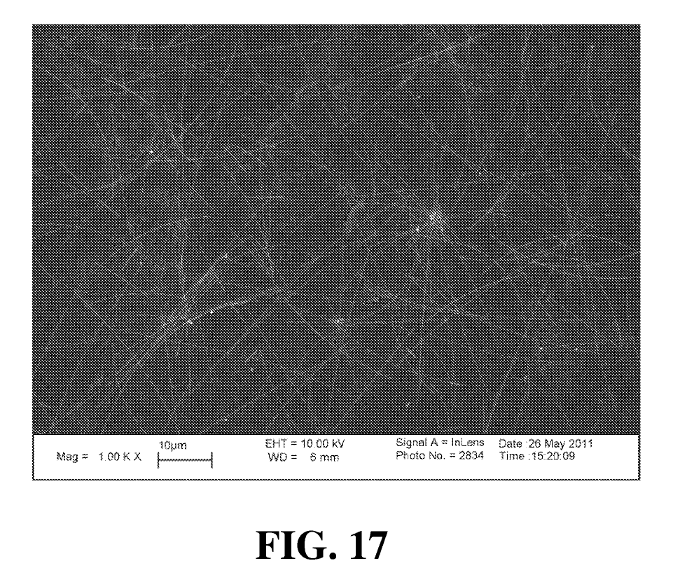

The reaction product was then washed with acetone and isopropanol, then centrifuged. The yield of silver ions to silver nanowires was 87.4%. The average nanowire diameter was determined by scanning electron microscopy to be 48±12 nm and the average nanowire length was 16±12 μm. FIGS. 16 and 17 show scanning electron micrographs of the purified silver nanowire product.

### Example 16

A 500 mL reaction flask containing 470 mL EG, 5.0 g PVP, 19.2 mg ammonium chloride, and 16.1 mg ammonium bromide was heated to 160° C. while bubbling nitrogen through its contents using a TEFLON® fluoropolymer tube. After the flask's contents reached 160° C., bubbling was discontinued and the reaction flask headspace was instead blanketed with nitrogen. 30 mL of 0.324 M AgNO₃ in EG, which had been degassed by bubbling nitrogen through it, was then added to the reaction flask over 29 min using a syringe pump. After addition of the AgNO₃ solution, the flask was held at temperature for 25 min, after which the reaction was quenched by immersing the flask in ice.

The reaction product was then washed with acetone and isopropanol, then centrifuged. The yield of silver ions to silver nanowires was 63.4%. The average nanowire diameter was determined by scanning electron microscopy to be 47±13 nm and the average nanowire length was 14±13 μm.

The invention has been described in detail with reference to particular embodiments, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed:

1. A method comprising:
providing at least one first composition comprising at least one first reducible metal ion, and
reducing the at least one first reducible metal ion to at least one first metal nanowire in the presence of at least one bromide ion, at least one chloride ion, at least one first alkali metal ion, and at least one second alkali metal ion,
wherein the at least one first alkali metal ion and the at least one second alkali metal ion have different atomic numbers.

2. The method according to claim 1, wherein the at least one first alkali metal ion or the at least one second alkali metal ion comprise a sodium ion or a potassium ion.

3. The method according to claim 1, wherein the at least one first reducible metal ion comprises at least one of a coinage metal ion, or an ion of an IUPAC Group 11 element, or a silver ion.

4. The at least one first metal nanowire produced according to the method of claim 1.

5. A method comprising:
providing at least one first composition comprising at least one first reducible metal ion, and
reducing the at least one first reducible metal ion to at least one first metal in the presence of at least one bromide ion and at least one chloride ion,
wherein the at least one chloride ion is provided by at least one first compound represented by NHₙR₄₋ₙCl, where n is 0, 1, 2, 3, or 4, or the at least one bromide ion is provided by at least one second compound represented by NHₙR₄₋ₘBr, where m is 0, 1, 2, 3, or 4.

6. The method according to claim 5, wherein the at least one first compound comprises at least one of ammonium chloride or tetramethylammonium chloride.

7. The method according to claim 5, wherein the at least one second compound comprises at least one of ammonium bromide or tetramethylammonium bromide.

8. The method according to claim 5, wherein the reduction occurs in the presence of at least one alkali metal ion.

9. The method according to claim 5, wherein the at least one first reducible metal ion comprises at least one of a coinage metal ion, or an ion of an IUPAC Group 11 element, or a silver ion.

10. The at least one first metal nanowire produced according to the method of claim 5.
